(19) United States
(12) Patent Application Publication
(10) Pub. No.: US 2007/0139282 A1
(43) Pub. Date: Jun. 21, 2007

(54) Antenna and portable wireless apparatus including the same

(75) Inventor: Shinichi Haruyama, Yokohama-si (JP)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/642,419

(22) Filed: Dec. 20, 2006

(30) Foreign Application Priority Data
Dec. 20, 2005 (JP) 2005-365826
Jul. 24, 2006 (KR) 2006-68958

(51) Int. Cl. H01Q 1/24

(52) U.S. Cl. 343/702

(57) ABSTRACT

Provided are an antenna and a portable wireless apparatus including the antenna. The antenna includes a plurality of antenna elements each having different frequency properties, and a branching filter having a plurality of filters which are connected to the antenna elements, respectively, the filters having pass bands corresponding to frequency properties of the connected antenna elements, and restricting transmission/reception bands of the antenna element to the respective pass bands. Accordingly, since only a single antenna element having a resonant frequency corresponding to used frequency is selected by a filter and functions as an antenna independently, the antenna having a broad band, a small size and a simple structure, and the portable wireless apparatus including the same is provided.

### PRIORITY

This application claims the benefit of Japanese Patent Application No. 2005-365826, filed on Dec. 20, 2005, in the Japanese Intellectual Property Office, and Korean Patent Application No. 10-2006-0068958, filed on Jul. 24,2006, in the Korean Intellectual Property Office, the contents of both of which are incorporated herein by reference.

### BACKGROUND OF THE INVENTION

1. Field of the Invention

The present invention relates generally to a portable wireless apparatus, and more particularly, to an antenna that can operate with a broad band of frequencies using a plurality of antenna elements, and a portable wireless apparatus including the same.

2. Description of the Related Art

As terrestrial digital multimedia television broadcasting is becoming more commonly used, there has been active research on portable wireless apparatuses such as mobile telephones, a Personal Digital Assistants (PDA), portable televisions, and notebook computers, which can receive terrestrial digital multimedia television broadcasting. In terrestrial digital multimedia broadcasting, a frequency band of VHF (Very High Frequency) and UHF (Ultra High Frequency) of conventional analog television may be used. For example, a UHF band in the range of 470 through 770 MHz may be used in Japan while a VHF band in the range of 170 through 220 MHz may be used in Korea. Portable wireless apparatuses ideally have a small size, thus requiring a high performance, small antenna to be included therein.

Generally, a portable wireless apparatus includes a monopole antenna having a simple structure. When a frequency to be received by the monopole antenna is f_{c}, it uses an antenna element having a quarter a wavelength λ (=c/f_{c}; c is a velocity of light). In addition, the monopole antenna uses a ground of the portable wireless apparatus as an antenna ground plane. FIG. 1 is a diagram illustrating a conventional monopole antenna formed on a basket body. Referring to FIG. 1, a monopole antenna 20a, which has a straight line shape, has a physical length of λ/4. For example, when the monopole antenna is used for UHF band (mean frequency f_{c}=620MHz) which is a band width of a terrestrial digital multimedia television broadcasting in Japan, it has the physical length of about 140 mm. A helical antenna 20b has a spiral shape, and thus a length of the winding antenna may be reduced to λ_{g}/4.

FIG. 2 is a graph illustrating frequency properties of the monopole antenna of FIG. 1. It is known to those of ordinary skill in the art that a relative band width Δf/f_{c} of a monopole antenna having a straight line shape is 10% or less. Δf is a band width of received frequencies of an antenna. For example, in UHF band, Δf is about 60 MHz, and it cannot reach 300 MHz covering all broadcasting band widths. Helical shaped antennas have smaller rate band and Δf. Accordingly, the conventional monopole antenna cannot receive a broad bands covering all band of a terrestrial digital multimedia television broadcasting.

As illustrated in FIG. 3, it is known to those of ordinary skill in the art that a plurality of antenna elements having different resonant frequencies can be connected in parallel to a feeder in a multi-resonant monopole antenna, as one solution to solve these above problems. Referring to FIG. 3, three antenna elements 21a, 21b and 21c included in the multi-resonant antenna have different lengths, and they have different resonant frequencies f1, f2 and f3 corresponding to each of the lengths. Quarter waves λ_{gf1}/4, λ_{gf2}/4 and λ_{gf3}/4 corresponding to the resonant frequencies are each lengths of the antenna elements 21a, 21b and 21c, respectively.

In the multi-resonant monopole antenna, power having a high frequency is applied only to an antenna element corresponding to a used frequency. The three antenna elements are operated independently. Properties of each of the antenna elements are summed to achieve a frequency property of all antennas which is a broad band as illustrated in FIG. 4. However, since the antenna elements, when power is not supplied thereto, also function effectively as a conductive rod of which one end is electrically connected to a ground plate, each of the resonant frequencies of the antenna elements is shifted from f1, f2 and f3.

FIG. 5 is a diagram illustrating an example of a conventional multi-resonant monopole antenna. In the multi-resonant antenna, a power supplier 14 is commonly formed with respect to three parallel antenna elements 22a, 22b and 22c having different lengths λ_{gf1}/4, λ_{gf2}/4 and λ_{gf3}/4 respectively corresponding to three resonant frequencies.

FIG. 6 is an equivalent circuit illustrating the multi-resonant monopole antenna of FIG. 5. The equivalent circuit is operated using a frequency f3 of FIG. 5. Here, each of the antenna elements 22a, 22b and 22c is ideally independent from each other. However, when each of the resonant frequencies is approximately similar, the antenna elements are connected to each other. Thus, the antenna elements 22a and 22b using the f1 and the f2 are operated as reactance elements X1 and X2, and the resonant frequency is shifted from an original value f3.

Since an input impedance is shifted from an original value, it requires one matching circuit to be added to the power supplier 14. However, when the matching circuit is added, frequency properties become a narrow band. In addition, an antenna gain is deteriorated by a high frequency loss in the matching circuit.

In order to solve these problems, a multi-resonant monopole antenna having a selector switch can be used as illustrated in FIG. 7. Referring to FIG. 7, switches 25a, 25b and 25c are formed on a feeder of each of the antenna elements 22a, 22b and 22c, respectively. The switch is controlled by a switch control circuit 26 arranged in a base of the antenna to selectively connect the antenna elements to the power supplier 14.

Ideally, the multi-resonant monopole antenna is operated with each of the antenna elements 22a, 22b and 22c to be independent from each other. However, a control circuit for the selector switch is required. The switch inhibits the manufacture of an antenna having a small size, and it has a complicated structure and numerous components which increases manufacturing costs.

### SUMMARY OF THE INVENTION

The present invention provides an antenna which has a small size and a simple structure for good control of frequency properties, and a portable wireless apparatus including the same.

According to the present invention, there is provided an antenna including a plurality of antenna elements each having different frequency properties, and a branching filter including a plurality of filters which are connected to the antenna elements respectively, said filters having pass bands corresponding to frequency properties of the connected antenna elements, and restricting transmission/reception bands of the antenna elements to the respective pass bands.

A central frequency of a pass band of the filter may be the same as a resonant frequency of the antenna element which is connected to the filter.

The antenna elements and the filters may have frequency properties which are distributed on a predetermined position of a frequency axis without a gap.

The antenna element may be formed on a printed circuit board to have a print pattern.

The filter may be any one of a surface acoustic wave filter, an LC resonance circuit and a dielectric resonator filter.

According to the present invention, there is provided a portable wireless apparatus including the antenna.

### BRIEF DESCRIPTION OF THE DRAWINGS

The above and other features and advantages of the present invention will become more apparent by describing in detail preferred embodiments thereof with reference to the attached drawings in which:

FIG. 1 is a diagram illustrating a conventional monopole antenna;

FIG. 2 is a graph illustrating frequency properties of the monopole antenna of FIG. 1;

FIG. 3 is a diagram illustrating a conventional multi-resonant antenna;

FIG. 4 is a graph illustrating frequency properties of the multi-resonant antenna of FIG. 3;

FIG. 5 is a diagram illustrating an example of a conventional multi-resonant monopole antenna;

FIG. 6 is an equivalent circuit illustrating the multi-resonant monopole antenna of FIG.5;

FIG. 7 is a diagram illustrating a conventional multi-resonant monopole antenna having a selector switch;

FIG. 8 is a diagram illustrating an antenna according to the present invention;

FIG. 9 is an electrical equivalent circuit diagram of a SAW filter;

FIGS. 10A and 10B are graphs illustrating frequency properties of a SAW filter and SAW branching filter, according to the present invention; and

FIG. 11 is a view illustrating the antenna of FIG. 8.

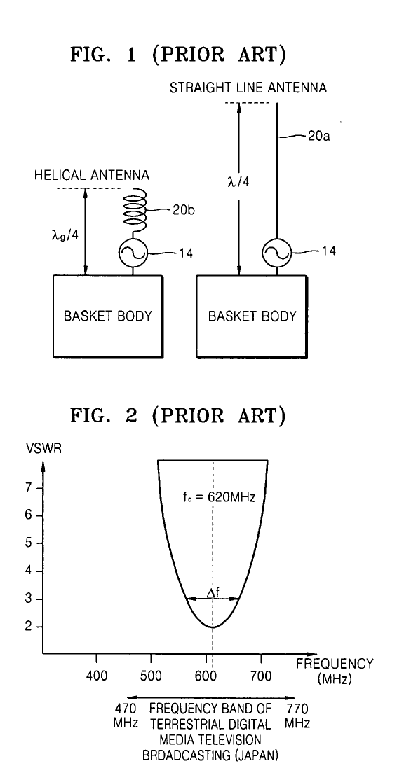

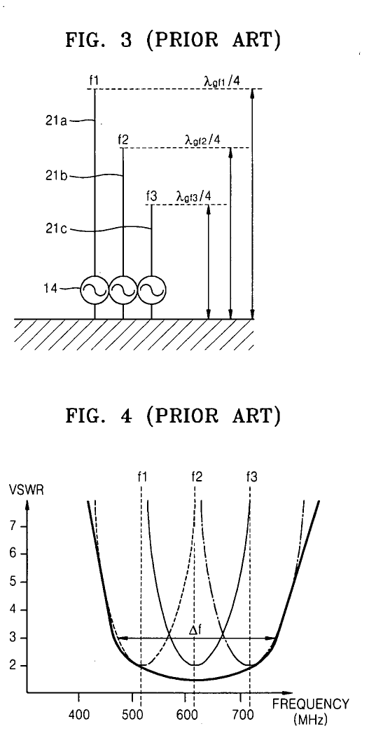

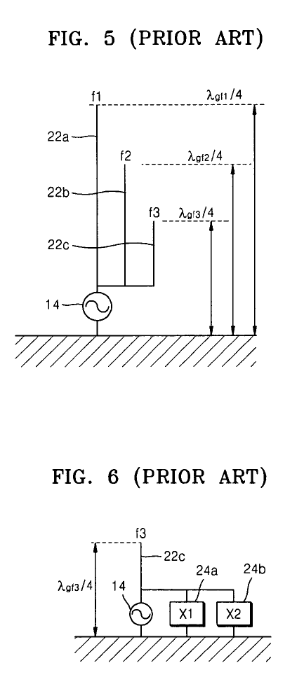

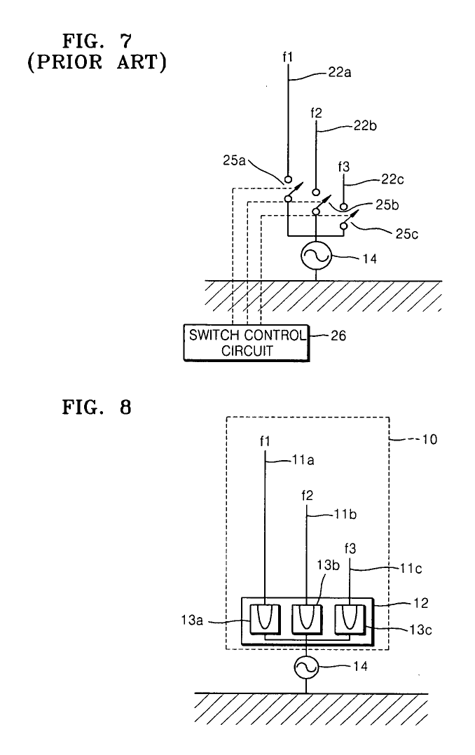

### DETAILED DESCRIPTION OF THE PREFERRED EMBODIMENTS

The present invention will now be described more fully with reference to the accompanying drawings, in which preferred embodiments of the invention are shown. The invention may, however, be embodied in various forms and should not be construed as being limited to the embodiments set forth herein; rather, these embodiments are provided to fully convey the concept of the invention to those skilled in the art.

FIG. 8 is a diagram illustrating an antenna 10, according to the present invention. Referring to FIG. 8, the antenna 10 includes first, second and third antenna elements 11a, 11b and 11c, and a SAW branching filter 12. Power fed to the antenna 10 is provided from a power supplier 14, and it passes through the SAW branching filter 12 to be provided to the first, second and third antenna elements 11a, 11b and 11c.

Each of the first, second and third antenna elements 11a, 11b and 11c is a conductor having a ¼ wavelength of a corresponding resonant frequency. Here, resonances of the first, second and third antenna elements 11a, 11b and 11c are each f1, f2 and f3, respectively. The first, second and third antenna elements 11a, 11b and 11c are connected in parallel to the power supplier 14.

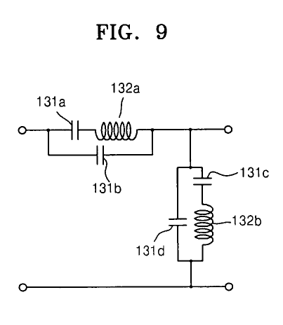

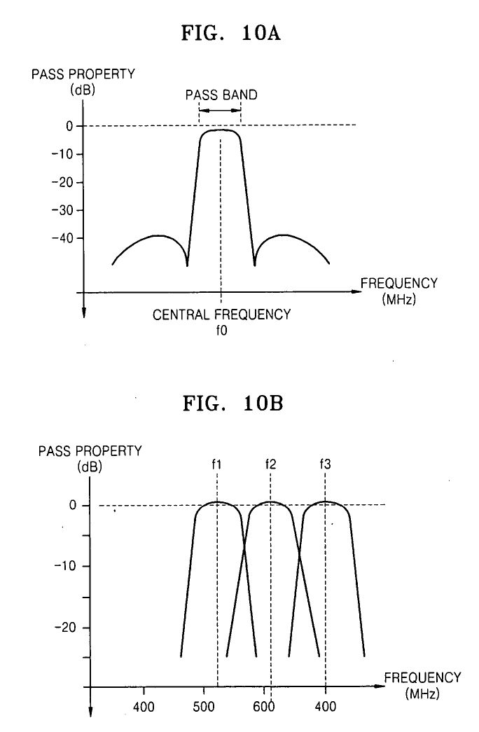

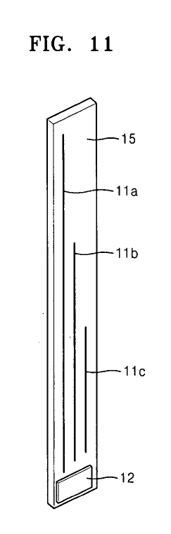

The SAW branching filter 12 includes first through third SAW filters 13a, 13b and 13c. A SAW filter is a filter device using a surface acoustic wave. An electrical equivalent circuit of the SAW filter is illustrated in FIG. 9. The SAW filter functions as a band pass filter passing only an electrical signal in a predetermined frequency range. For example, as illustrated in FIG. 10A, the SAW filter has filter pass properties that block the passing of an electric signal except in a narrow band of frequencies.

Since an insertion loss of the SAW filter is 1 dB or less, an antenna gain of the SAW branching filter 12 is not deteriorated.

Here, central frequencies of pass bands of the first, second and third SAW filters 13a, 13b, and 13c are f1, f2 and f3, respectively, which are the same as the resonant frequency of the each of the antennas. The filter property of the SAW branching filter 12 is illustrated in FIG. 10B.

Referring back to FIG. 8, the first, second and third antenna elements 11a, 11b and 11c of the antenna 10 are respectively connected to the first, second and third SAW filters 13a, 13b and 13c, which have the same operating frequencies as the resonant frequencies of the first, second and third antenna elements 11a, 11b and 11c respectively. That is, the first antenna element 11a having an operating frequency of f1 is connected to the first SAW filter 13a. The second antenna element 11b having an operating frequency of the f2 is connected to the second SAW filter 13b. The third antenna element 11c having an operating frequency of the f3 is connected to the third SAW filter 13c.

The operation of the antenna 10 will be described for a case when a frequency of f3 is used in the antenna 10. Referring to FIG. 10b, the first and second SAW filters 13a and 13b having respective central frequencies f1 and f2 block an electrical signal of f3, since the f3 is in a stop band, that is, not a pass band in reference to the first and second SAW filters 13a and 13b. Accordingly, the third antenna element 11c is insulated from the first and second antenna elements 11a and 11b respectively connected to the first and second SAW filters 13a and 13b.

The electrical signal of frequency f3 can pass the third SAW filter since the third SAW filter 13c has the central frequency f3. Accordingly, the third antenna element 11c is electrically connected to operate as the antenna 10.

The third antenna element 11c is independent from the first and second antenna elements 11a and 11b in view of an operation for a frequency f3. This is equivalent to a case where the antenna 10 only includes the third antenna element 11c.

Likewise, when a frequency of f1 or f2 is used in the antenna 10, only the first antenna element 11a or the second antenna element 11b, respectively, is electrically connected to the antenna 10.

Based on the used frequency, the first, second and third antenna elements 11a, 11b and 11c are automatically selected by the first, second and third SAW filters 13a, 13b and 13c, and thus a total receive band width of the antenna 10 is a broad band width. In addition, a plurality of antennas and SAW filters have frequency properties which are distributed without a gap on a frequency axis. Thus, improved broad band properties can be achieved.

FIG. 11 is a view illustrating the antenna 10 of FIG. 8. The first, second and third antenna elements 11a, 11b and 11c are formed on a printed circuit board 15 to have a printed pattern. The SAW branching filter 12 is formed on the antenna 10. An input terminal (not shown) formed on a bottom end of the SAW branching filter 12 is connected to a feed terminal (not shown) formed on a bottom end surface of the printed circuit board 15. Output terminals formed on a top end of the SAW branching filter 12 are each connected to the first, second and third antenna elements 11a, 11b and 11c respectively corresponding to the first, second and third SAW filters (13a, 13b and 13c of FIG. 8).

The SAW branching filter 12 may be formed as a bare chip, or alternatively may be packaged in a ceramic package or the like. The size of the SAW branching filter 12 is about 3 mm×3 mm when the central frequency is about 620 MHz.

According to the present invention, the first, second and third SAW filters 13a, 13b and 13c having pass bands corresponding to the resonant frequencies f1, f2 and f3 of the first, second and third antenna elements 11a, 11b and 11c, respectively, are connected to the first, second and third antenna elements 11a, 11b and 11c, respectively. In addition, the first, second and third antenna elements 11a, 11b and 11c are connected in parallel to the power supplier 14. Thus, based on the used frequency, one antenna element can be automatically selected by the first, second and third SAW filters 13a, 13b and 13c to function as the antenna 10. Since the other antenna elements are insulated from the selected antenna element by the SAW filter, a real resonant frequency of the selected antenna element is not shifted from an originally designed frequency. In addition, since the SAW filter is used, the antenna 10 can be manufactured to have a small size and a simple structure.

It will be understood by those of ordinary skill in the art that a number of antenna elements, frequency properties fc and λf, and a method of distributing a plurality of antenna elements on the frequency axis may be designed according to broad band properties desired for the antenna 10.

Shapes of the antenna elements 11a, 11b and 11c are not limited to the print pattern illustrated in FIG. 4. That is, the antenna elements 11a, 11b and 11c may have be formed in shapes such as block, straight line, stick, or spiral shapes.

In addition, common filter devices such as an LC resonant circuit and a dielectric resonator filter, and the like can be used instead of the SAW filters 13a, 13b and 13c.

The above described antenna having a small size has improved broad band properties. Accordingly, it may be used in an antenna of a portable wireless apparatus in which a broad band is required. The portable wireless apparatus may be a mobile telephone, PDA or a portable television, a laptop computer. In particular, since the portable wireless apparatus for a terrestrial digital multimedia television broadcasting requires an antenna having a broad band which can receive various channels, the above described antennas may can be used in the portable wireless apparatus.

As described above, since only an antenna element having a resonant frequency which is the same as a used frequency selectively functions as an antenna by a filter, the broad band antenna, of which resonant frequency is not shifted from an original value by an electromagnetic binding between antenna elements, can be realized . In addition, when the SAW filter is used, an antenna having a small size is easily manufactured.

While the present invention has been particularly shown and described with reference to preferred embodiments thereof, it will be understood by those of ordinary skill in the art that various changes in form and details may be made therein without departing from the spirit and scope of the present invention as defined by the following claims.

What is claimed is:

1. An antenna comprising:
a plurality of antenna elements each having different frequency properties; and
a branching filter including a plurality of filters which are respectively connected to the antenna elements, said filters having pass bands corresponding to the frequency properties of the connected antenna elements, and restricting transmission/reception bands of the antenna elements to the respective pass bands.

2. The antenna of claim 1, wherein a central frequency of a pass band of each of the plurality of filters is the same as a resonant frequency of the antenna element to which the filter is connected.

3. The antenna of claim 1, wherein the antenna elements and the filters have frequency properties which are distributed on a predetermined band of a frequency axis without a gap.

4. The antenna of claim 1, wherein the antenna element is formed on a printed circuit board and has a printed pattern.

5. The antenna of claim 1, wherein each of the plurality of filters is one of a surface acoustic wave filter, an LC resonance circuit and a dielectric resonator filter.

6. A portable wireless apparatus including an antenna and a feeder feeding the antenna, wherein the antenna comprises:
a plurality of antenna elements each having different frequency properties; and
a branching filter including a plurality of filters which are connected to each of the antenna elements, respectively, said filters having pass bands corresponding to frequency properties of the connected antenna elements, and restricting transmission/reception bands of the antenna element to the respective pass bands.

7. The portable wireless apparatus of claim 6, wherein a central frequency of a pass band of each of the plurality of filters is the same as a resonant frequency of the antenna element to which the filter is connected.

8. The portable wireless apparatus of claim 6, wherein the antenna elements and the filters have frequency properties which are distributed on a frequency axis without a gap.

9. The portable wireless apparatus of claim 6, wherein the antenna element is formed on a printed circuit board and has a printed pattern.

10. The portable wireless apparatus of claim 6, wherein each of the plurality of filters is one of a surface acoustic wave filter, an LC resonance circuit and a dielectric resonator filter.
